(19) United States
(12) Patent Application Publication
(10) Pub. No.: US 2026/0184125 A1
(43) Pub. Date: Jul. 2, 2026

(54) TRAVELING BODY

(71) Applicant: DMG MORI CO., LTD., NARA (JP)

(72) Inventors: Hideki NAGASUE, NARA (JP); Ryota MAEDA, NARA (JP)

(73) Assignee: DMG MORI CO., LTD., NARA (JP)

(21) Appl. No.: 19/129,575

(22) PCT Filed: Mar. 5, 2024
(86) PCT No.: PCT/JP2024/008290

§ 371 Date: May 13, 2025

(30) Foreign Application Priority Data
Jul. 3, 2023 (JP) 2023-108983

(51) Int. Cl. B60G 3/14; B62D 61/10; B62D 61/12; B62D 63/02

(52) U.S. Cl. CPC B60G 3/14; B62D 61/10; B62D 61/12; B62D 63/02

(57) ABSTRACT

A traveling body includes: a base portion; a wheel unit including a first wheel serving as a driving wheel, the first wheel being supported movably by the base portion; a second wheel spaced apart from the first wheel in a front-rear direction, and serving as a driven wheel that is driven to rotate as the first wheel rotates; a suspension mechanism that generates an urging force; and a link mechanism that is connected to the suspension mechanism and the wheel unit, and subjected to the urging force from the suspension mechanism to press the first wheel toward a lower surface. The suspension mechanism and the link mechanism are disposed between the first wheel and the second wheel in the front-rear direction.

### TECHNICAL FIELD

The present invention relates to a traveling body.

### BACKGROUND ART

For example, Japanese Patent Laying-Open No. 2021-123249 (PTL 1) discloses a traveling device including a front first wheel serving as a driven wheel configured as an omni wheel, a rear first wheel serving as a driving wheel and located rearward of the front first wheel, a second wheel serving as a driven wheel configured as an omni wheel and located further rearward of the rear first wheel, and a support arm supported by a frame in such a manner that the support arm is swingable within a vertical plane along the traveling direction, and the support arm has opposite ends on which the front first wheel and the rear first wheel are rotatably mounted, respectively.

### Citation List

### Patent Literature

PTL 1: Japanese Patent Laying-Open No. 2021-123249

### SUMMARY OF INVENTION

### Technical Problem

As an example of a moving device, an AMR (Autonomous Mobile Robot) that transports an object to any place is used in a factory or the like. A traveling body included in such an AMR is required to travel over cable ducts or the like that cover wires or pipes routed on the floor of a factory, and therefore required to exhibit a high traveling performance. In a rack warehouse or the like, the traveling body is required to move into a place located directly below an object to be transported, and therefore, the height of the traveling body is also required to be kept low in order to improve the traveling performance.

An object of the present invention is therefore to provide a traveling body, a moving device, an AMR, and a wheel swing mechanism and the like, capable of traveling over a protrusion such as a cable duct while the height of the traveling body is kept low.

### Solution to Problem

A traveling body according to the present invention includes: a base portion; a wheel unit including a first wheel serving as a driving wheel, the first wheel being supported movably by the base portion; a second wheel spaced apart from the first wheel in a front-rear direction, and serving as a driven wheel that is driven to rotate as the first wheel rotates; a suspension mechanism that generates an urging force; and a link mechanism that is connected to the suspension mechanism and the wheel unit, and subjected to the urging force from the suspension mechanism to press the first wheel toward a lower surface. The suspension mechanism and the link mechanism are disposed between the first wheel and the second wheel in the front-rear direction.

Further, the present invention provides a moving device (such as AMR, moving robot, and autonomous moving robot) for which such a traveling body is used, and provides a wheel swing mechanism used for such a traveling body.

### Advantageous Effects of Invention

According to the present invention, a traveling body, a moving device, an AMR, and a wheel swing mechanism and the like, capable of traveling over a protrusion such as a cable duct while the height of the traveling body is kept low, can be provided.

### BRIEF DESCRIPTION OF DRAWINGS

FIG. 1 is a perspective view showing a moving device for which a traveling body is used according to an embodiment of the present invention.

FIG. 2 is a perspective view showing the traveling body in FIG. 1.

FIG. 3 is a top view showing the traveling body in FIG. 1.

FIG. 4 is a rear view showing the traveling body as seen in the direction indicated by an arrow IV in FIG. 3.

FIG. 5 is a top view showing a modification of an arrangement of a traveling motor in FIG. 3.

FIG. 6 is a side view showing the traveling body in FIG. 1.

FIG. 7 is a cross-sectional view showing the traveling body in a range enclosed by a two-dot-dashed line VII in FIG. 4, and a bottom plate of a controller.

FIG. 8 is a perspective view showing a support structure for a first wheel in the traveling body in FIG. 2.

FIG. 9 is a side view showing the support structure (a neutral state of a suspension mechanism) for the first wheel in FIG. 8.

FIG. 10 is a side view showing the support structure (a shrunk state of the suspension mechanism) for the first wheel in FIG. 8.

FIG. 11 is a side view showing the support structure (a stretched state of the suspension mechanism) for the first wheel in FIG. 8.

FIG. 12 is a cross-sectional view schematically showing a mechanism for restricting a downward swing end of an arm member.

FIG. 13 is a cross-sectional view schematically showing a mechanism for restricting an upward swing end of the arm member.

FIG. 14 is a perspective view showing a holding mechanism for a wheel unit (before a bolt is inserted).

FIG. 15 is a perspective view showing the holding mechanism for the wheel unit (after the bolt is inserted).

FIG. 16 is a side view showing the traveling body when the first wheel is lifted.

FIG. 17 is a perspective view showing a modification of the moving device in FIG. 1.

FIG. 18 is a plan view for illustrating the position of the center of gravity in the moving device in FIG. 17.

### DESCRIPTION OF EMBODIMENTS

Embodiments of the present invention are described with reference to the drawings. In the drawings referred to below, the same or corresponding members are denoted by the same reference numerals.

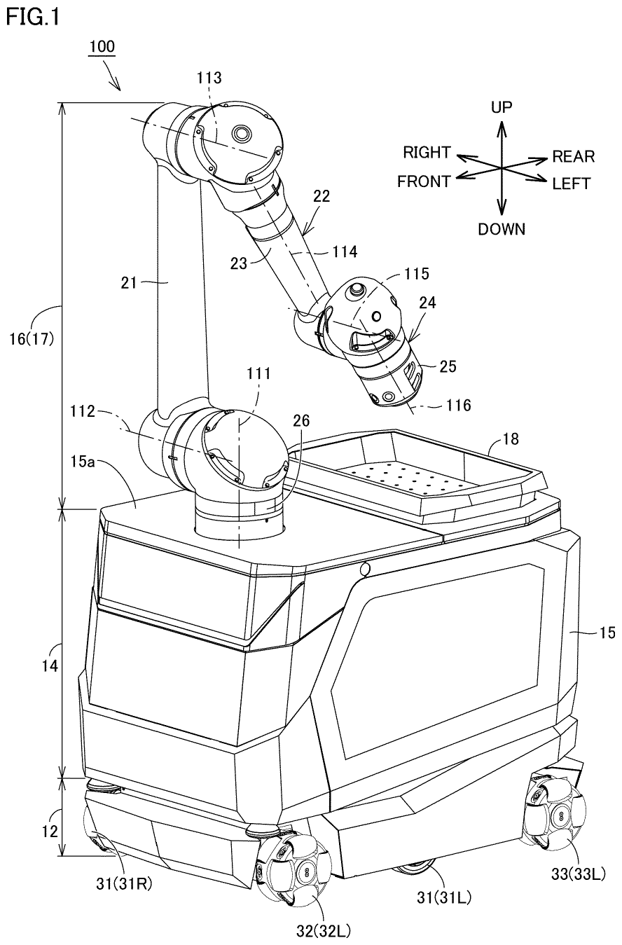

FIG. 1 is a perspective view showing a moving device for which a traveling body is used according to an embodiment of the present invention. Referring to FIG. 1, moving device 100 is a device capable of traveling autonomously under computer control. Moving device 100 is an AMR (Autonomous Mobile Robot), and transports an object such as work or tool to any place.

In FIG. 1 and drawings referred to below, six directions: frontward direction, rearward direction, rightward direction, leftward direction, upward direction, and downward direction, are shown as appropriate. The frontward direction and the rearward direction are directions in which moving device 100 (traveling body 12) travels straight, and are opposite to each other. The rightward direction is the direction toward the right with respect to moving device 100 (traveling body 12) directed frontward. The leftward direction is the direction toward the left with respect to moving device 100 (traveling body 12) directed frontward, and is opposite to the rightward direction. The upward direction is the direction toward the sky with respect to moving device 100 (traveling body 12), and the downward direction is the direction toward a lower surface (road surface) side on which moving device 100 (traveling body 12) travels.

In the present embodiment, the direction in which a robot 16 is located with respect to a tray 18 described later herein is referred to as frontward direction, and the opposite direction is referred to as rearward direction. The frontward direction and the rearward direction, however, may be defined in any manner.

In the following description, a reference numeral denoting the right one of a pair of right and left components is followed by “R” and a reference numeral denoting the left one thereof is followed by “L.” Reference numerals followed by none of “R” and “L” are used to describe common features to the right and left components.

### Structure of Moving Device 100

First, a structure of moving device 100 is described. Referring to FIG. 1, moving device 100 includes traveling body 12, a controller 14, and robot 16 such as a robot arm 17. Traveling body 12 is configured to be capable of traveling with wheels driven by means of a traveling motor 57 described later herein. Controller 14 and robot 16 are mounted on traveling body 12.

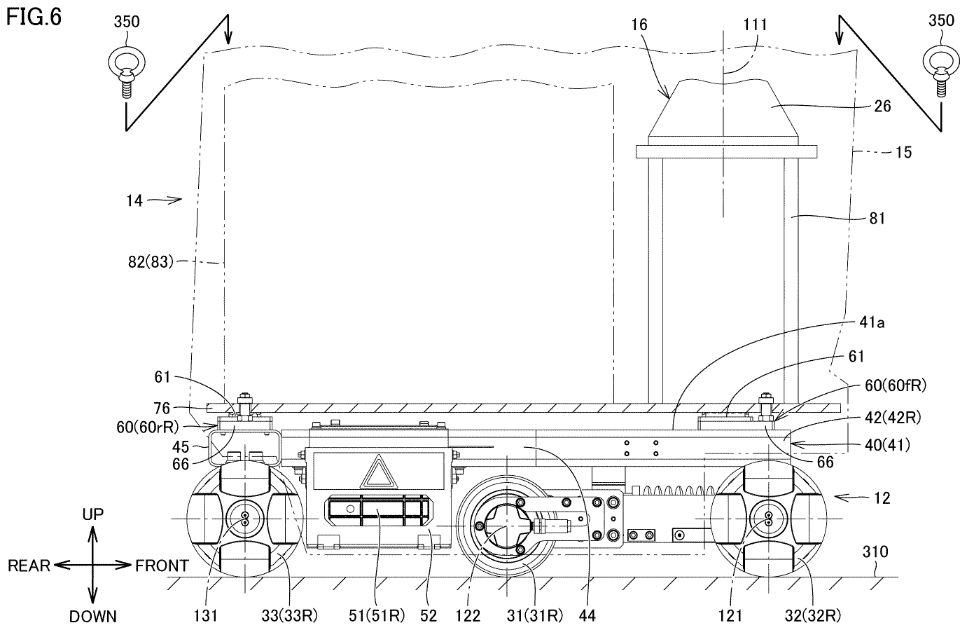

Controller 14 controls traveling of traveling body 12 and controls operation of robot 16. Controller 14 includes a cover 15. Cover 15 is a cover body that presents the appearance of controller 14 and forms an internal space on traveling body 12. Various electronic devices 82 (see FIG. 6) for moving traveling body 12 and causing robot 16 to operate, as well as a driving motor for robot 16, for example, are accommodated inside cover 15.

On a top surface 15a of cover 15, tray 18 is provided on which an object to be transported is to be placed. Robot 16 is configured to be capable of grasping an object to be transported. Robot 16 is provided on top surface 15a of cover 15 and extends upward from top surface 15a of cover 15. Robot 16 and tray 18 are arranged in the front-rear direction.

Robot 16 includes a pedestal portion 26, a first movable portion 21, a second movable portion 22, and a third movable portion 24. Pedestal portion 26 protrudes from top surface 15a of cover 15. Pedestal portion 26 is rotatable about a rotational center axis 111. Rotational center axis 111 extends in the top-bottom direction (vertical direction). Pedestal portion 26 extends along rotational center axis 111. Pedestal portion 26 rotates about rotational center axis 111.

First movable portion 21 is connected to pedestal portion 26 so as to be rotatable about a rotational center axis 112. Rotational center axis 112 extends in a direction orthogonal to rotational center axis 111. Rotational center axis 112 extends in the horizontal direction. First movable portion 21 extends from pedestal portion 26 in the radial direction of rotational center axis 112. First movable portion 21 swings about rotational center axis 112.

Second movable portion 22 is connected to first movable portion 21 so as to be rotatable about a rotational center axis 113. Rotational center axis 113 extends parallel to rotational center axis 112. Rotational center axis 113 extends in the horizontal direction. Second movable portion 22 extends from first movable portion 21 in the radial direction of rotational center axis 113.

Second movable portion 22 includes a rotatable portion 23. Rotatable portion 23 is rotatable about a rotational center axis 114. Rotational center axis 114 extends in the radial direction of rotational center axis 113. Rotatable portion 23 extends along rotational center axis 114. Second movable portion 22 (rotatable portion 23) swings about rotational center axis 113 and also rotates about rotational center axis 114.

Third movable portion 24 is connected to second movable portion 22 (rotatable portion 23) so as to be rotatable about rotational center axis 115. Rotational center axis 115 extends parallel to rotational center axis 112 and rotational center axis 113. Rotational center axis 115 extends in the horizontal direction. Third movable portion 24 extends from second movable portion 22 (rotatable portion 23) in the radial direction of rotational center axis 115.

Third movable portion 24 includes a rotatable portion 25. Rotatable portion 25 is rotatable about a rotational center axis 116. Rotational center axis 116 extends in the radial direction of rotational center axis 115. Rotatable portion 25 extends along rotational center axis 116. Third movable portion 24 (rotatable portion 25) swings about rotational center axis 115 and also rotates about rotational center axis 116.

An end effector (not shown) for grasping an object to be transported is attached to the leading end of third movable portion 24 (rotatable portion 25).

In connection with the present embodiment, regarding robot 16, robot arm 17 of which six axes (rotational center axes 111 to 116) are controllable is described. Alternatively, a robot arm of which multiple axes other than the six axes are controllable may be mounted on traveling body 12. Robot 16 may for example be a forklift-type robot. In this case, robot 16 may be a robot capable of lifting a tray with a fork(s), placing the lifted tray in place, lifting a new tray with the fork(s), and placing the new tray on top surface 15a of cover 15.

### Structure of Traveling Body

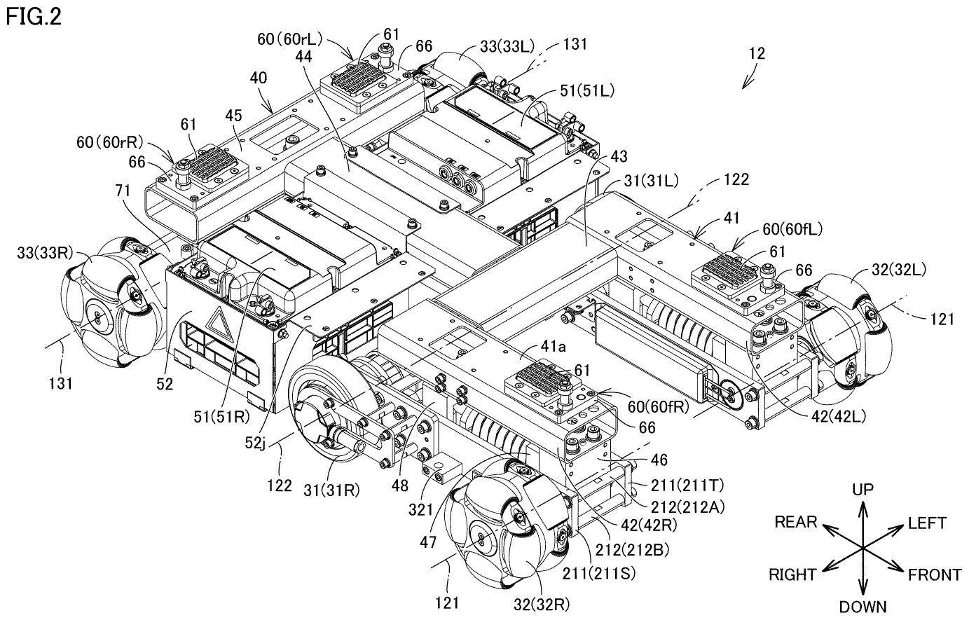

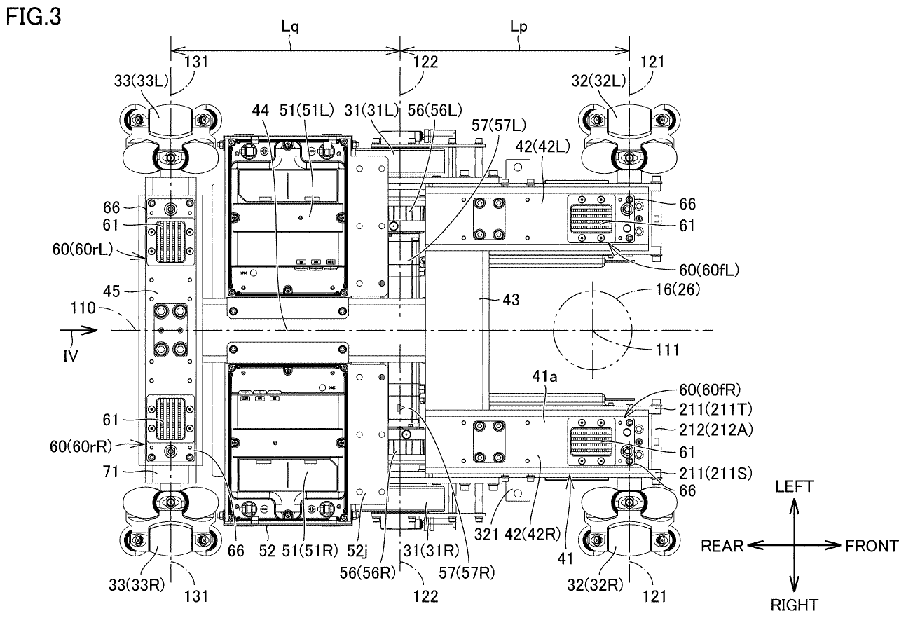

Next, a structure of traveling body 12 is described. FIG. 2 is a perspective view showing the traveling body in FIG. 1. FIG. 3 is a top view showing the traveling body in FIG. 1. Traveling body 12 has a laterally symmetrical structure about a centerline 110 (see FIG. 3), which is centerline 110 of traveling body 12 assumed to extend in the front-rear direction.

Referring to FIGS. 1 to 3, traveling body 12 includes a first wheel 31 (31R, 31L), a traveling motor 57 (57R, 57L), and a reducer 56 (56R, 57L).

First wheel 31 is a driving wheel. First wheel 31 is rotatable about a second axis 122. Second axis 122 is an imaginary straight line corresponding to the rotational center of first wheel 31 and extends in the left-right direction. Traveling motor 57 is configured as a servo motor or a stepping motor of which number of revolutions (rotational speed) and rotational direction can be controlled. Rotational motion is input from traveling motor 57 to first wheel 31 to cause the first wheel to rotate. Reducer 56 slows down the rotations from traveling motor 57 and transmits the rotations to first wheel 31.

First wheel 31R and first wheel 31L are spaced apart from each other in the left-right direction. First wheel 31R is connected to traveling motor 57R via reducer 56R. First wheel 31L is connected to traveling motor 57L via reducer 56L. First wheel 31R and first wheel 31L are driven to rotate independently of each other. First wheel 31 can rotate in the forward direction and the reverse direction. First wheel 31 is rotatable at any number of revolutions (rotational speed).

Traveling motor 57 outputs rotational motion about second axis 122. Traveling motor 57, reducer 56, and first wheel 31 are arranged in series in the left-right direction. Traveling motor 57 is disposed between first wheel 31R and first wheel 31L in the left-right direction. Traveling motor 57R is disposed between first wheel 31R and traveling motor 57L in the left-right direction. Traveling motor 57L is disposed between first wheel 31L and traveling motor 57R in the left-right direction.

Traveling body 12 further includes a second wheel 32 (32R, 32L) and a third wheel 33 (33R, 33L).

Second wheel 32 is rotatable about a first axis 121. First axis 121 is an imaginary straight line corresponding to the rotational center of second wheel 32 and extends in the left-right direction. Second wheel 32 is configured as an omni wheel in which a wheel supported rotatably about first axis 121 and a plurality of rollers provided on the outer periphery of the wheel and rotatable about a rotational center axis extending in a direction orthogonal to first axis 121 are combined.

Second wheel 32R and second wheel 32L are spaced apart from each other in the left-right direction. First wheel 31 and second wheel 32 are spaced apart from each other in the front-rear direction. Second wheel 32 is provided frontward of first wheel 31. Second wheel 32R is provided at the right front corner of traveling body 12. Second wheel 32L is provided at the left front corner of traveling body 12.

Third wheel 33 is rotatable about an eighth axis 131. Eighth axis 131 is an imaginary straight line and extends in the left-right direction. Third wheel 33 is configured as an omni wheel in which a wheel rotatable about eighth axis 131 and a plurality of rollers provided on the outer periphery of the wheel and rotatable about a rotational center axis extending in a direction orthogonal to eighth axis 131 are combined.

Third wheel 33R and third wheel 33L are spaced apart from each other in the left-right direction. First wheel 31 and third wheel 33 are spaced apart from each other in the front-rear direction. Third wheel 33 is provided rearward of first wheel 31. Third wheel 33R is provided at the right rear corner of traveling body 12. Third wheel 33L is provided at the left rear corner of traveling body 12.

The omni wheel forming third wheel 33 is identical to the omni wheel forming second wheel 32. As shown in FIG. 3, distance Lp between first wheel 31 and second wheel 32 in the front-rear direction is equal to distance Lq between first wheel 31 and third wheel 33 in the front-rear direction. The interval between second wheel 32R and second wheel 32L in the left-right direction is the same as the interval between third wheel 33R and third wheel 33L in the left-right direction. Second wheel 32 protrudes from first wheel 31 in the left-right direction. Third wheel 33 protrudes from first wheel 31 in the left-right direction.

Second wheel 32 and third wheel 33 are driven wheels. Second wheel 32 and third wheel 33 are driven to rotate as first wheel 31 rotates. When traveling body 12 is caused to travel on the lower surface by rotations of first wheel 31, a relative movement is generated between second wheel 32 and third wheel 33, and the lower surface with which second wheel 32 and third wheel 33 are in contact, which causes second wheel 32 and third wheel 33 to rotate. Second wheel 32 and third wheel 33, which are omni-wheels, are provided at the four corners of traveling body 12 as seen from the above, and have a function of receiving the weight of moving device 100.

Traveling body 12 further includes a base portion 40. Base portion 40 supports first wheel 31, traveling motor 57, reducer 56, second wheel 32, third wheel 33, and a battery 51, for example.

Base portion 40 further includes a frame member 41. Frame member 41 is formed of a metal frame material forming a framework of traveling body 12. Frame member 41 is constituted of pipe-shaped frame members each having a rectangular closed cross section. Frame member 41 is disposed parallel to the lower surface on which traveling body 12 travels.

Frame member 41 includes a first frame 42 (42R, 42L), a second frame 43, a third frame 44, and a fourth frame 45.

First frame 42 extends in the front-rear direction. In the top view shown in FIG. 3, first frame 42 has a rectangular shape with its longitudinal direction corresponding to the front-rear direction and its widthwise direction corresponding to the left-right direction. The front end portion of first frame 42 is located frontward of first axis 121, and the rear end portion of first frame 42 is located frontward of second axis 122. First frame 42R and first frame 42L are spaced apart from each other in the left-right direction. In the top view shown in FIG. 3, first wheel 31R and second wheel 32R are provided at respective positions located further from first frame 42 in the left-right direction.

Second frame 43 extends in the left-right direction. In the top view shown in FIG. 3, second frame 43 has a rectangular shape with its longitudinal direction corresponding to the left-right direction and its widthwise direction corresponding to the front-rear direction. Second frame 43 extends between first frame 42R and first frame 42L. The right end of second frame 43 is connected to first frame 42R, and the left end of second frame 43 is connected to first frame 42L.

In the top view shown in FIG. 3, pedestal portion 26 (rotational center axis 111) of robot 16 is located between first frame 42R and first frame 42L in the left-right direction. Rotational center axis 111 of pedestal portion 26 is located between first frame 42R and first frame 42L in the left-right direction and located on centerline 110 of traveling body 12 extending in the front-rear direction. Pedestal portion 26 (rotational center axis 111) is located frontward of first wheel 31 (second axis 122). Pedestal portion 26 (rotational center axis 111) is located frontward of second frame 43. Rotational center axis 111 is located rearward of first axis 121. The position, in the front-rear direction, of rotational center axis 111 of pedestal portion 26 matches the position, in the front-rear direction, of an elastic pad 61, which is described later herein.

Third frame 44 extends in the front-rear direction. In the top view shown in FIG. 3, third frame 44 has a rectangular shape with its longitudinal direction corresponding to the front-rear direction and its widthwise direction corresponding to the left-right direction. Third frame 44 extends on centerline 110 of traveling body 12 extending in the front-rear direction. Third frame 44 extends between second frame 43 and fourth frame 45. The front end of third frame 44 is connected to second frame 43, and the rear end of third frame 44 is connected to fourth frame 45.

Fourth frame 45 extends in the left-right direction. In the top view shown in FIG. 3, fourth frame 45 has a rectangular shape with its longitudinal direction corresponding to the left-right direction and its widthwise direction corresponding to the front-rear direction. In the top view shown in FIG. 3, fourth frame 45 extends on eighth axis 131.

First wheel 31 is supported by first frame 42 with a first block 46 and an arm member 211, which are described later herein, interposed therebetween. Second wheel 32 is supported by first frame 42 with first block 46, which is described later herein, interposed therebetween. Third wheel 33 is supported by fourth frame 45 with a support arm 71 and a support block 72, which are described later herein, interposed therebetween. Battery 51, described later herein, is supported by third frame 44 with a battery case 52 covering battery 51 interposed therebetween.

In the top view shown in FIG. 3, first wheel 31, second wheel 32, and third wheel 33 are provided at respective positions that do not overlap frame member 41 (first frame 42, second frame 43, third frame 44, and fourth frame 45).

First wheel 31, second wheel 32, and third wheel 33 cannot be steered in the left-right direction. Traveling body 12 moves straight forward in the front-rear direction, as the same rotations are applied to first wheel 31R and first wheel 31L, and turns in the left-right direction as rotations different from each other are applied respectively to first wheel 31R and first wheel 31L (2 wheel differential drive system).

More specifically, traveling body 12 moves straight forward (forward movement) by rotating first wheel 31R and first wheel 31L at the same number of revolutions in the forward direction. Traveling body 12 moves backward (backward movement) by rotating first wheel 31R and first wheel 31L at the same number of revolutions in the reverse direction.

Traveling body 12 turns leftward (left turn) by rotating first wheel 31L in the forward direction and rotating first wheel 31R in the forward direction at a higher number of revolutions than first wheel 31L. Traveling body 12 turns rightward (right turn) by rotating first wheel 31R in the forward direction and rotating first wheel 31L in the forward direction at a higher number of revolutions than first wheel 31R.

Traveling body 12 rotates by rotating first wheel 31R in the forward direction and rotating first wheel 31L in the reverse direction at the same rotational speed as first wheel 31R (anticlockwise rotation). Traveling body 12 rotates in the direction opposite to the above direction by rotating first wheel 31R in the reverse direction and rotating first wheel 31L in the forward direction at the same number of revolutions as first wheel 31R (clockwise rotation). The rotational center of traveling body 12 is ideally located on second axis 122 and corresponds to the intermediate position between first wheel 31R and first wheel 31L in the left-right direction (corresponds to the in-tersection of second axis 122 and centerline 110 of traveling body 12 extending in the front-rear direction).

In the present embodiment, distance Lp between first wheel 31 and second wheel 32 in the front-rear direction is equal to distance Lq between first wheel 31 and third wheel 33 in the front-rear direction. With such a configuration, the frictional forces generated between the lower surface and first wheels 31 and third wheels 33 are uniform, i.e., the frictional forces between the lower surface and the four wheels are uniform during the turning and rotating operations of traveling body 12, and therefore, control of traveling motor 57 can be facilitated.

Traveling body 12 further includes battery 51 (51R, 51L). Battery 51 is provided to serve as a motive power source of moving device 100, and supplies electric power to traveling motor 57 and a driving motor of robot 16, for example.

Battery 51 is provided rearward of first wheel 31. Battery 51 is provided between first wheel 31 and third wheel 33 in the front-rear direction. Battery 51 is located at a position adjacent to third frame 44 in the left-right direction. Battery 51R is provided rearward of first wheel 31R, reducer 56R, and traveling motor 57R. Battery 51L is provided rearward of first wheel 31L, reducer 56L, and traveling motor 57L. Cover 15 can be removed to draw out battery 51 in the left-right direction.

Wires extending from battery 51 toward controller 14 and robot 16 may be routed outside frame member 41 or may be routed inside frame member 41.

In the top view shown in FIG. 3, pedestal portion 26 (rotational center axis 111) of robot 16 is located frontward of first wheel 31, while battery 51 is located rearward of first wheel 31. With such a configuration, robot 16 which is a heavy object and on which a high load is applied as it is driven, as well as battery 51 which is also a heavy object can be supported by base portion 40 in a balanced manner in the front-rear direction. Thus, traveling of moving device 100 can be stabilized.

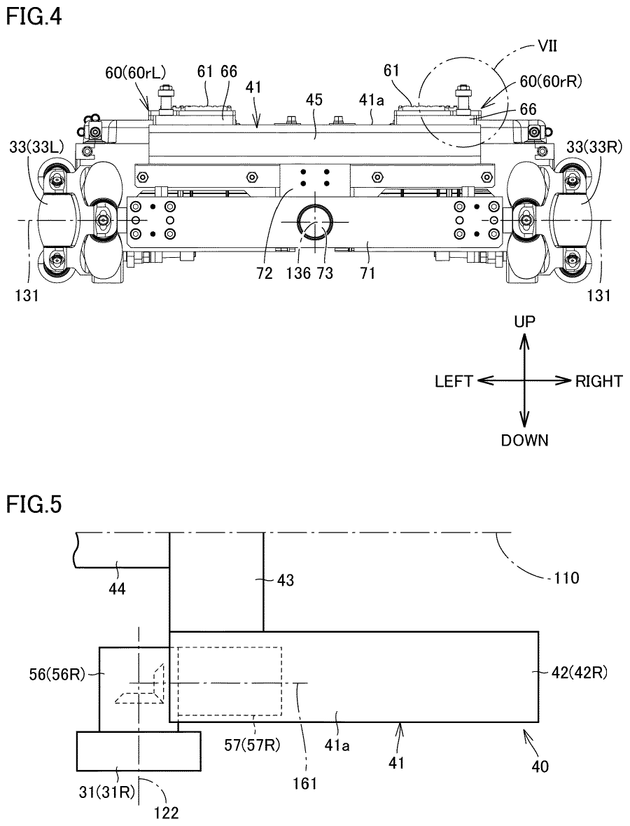

FIG. 4 is a rear view showing the traveling body as seen in the direction indicated by an arrow IV in FIG. 3. Referring to FIGS. 3 and 4, base portion 40 further includes a support arm 71 and a support block 72.

Support arm 71 is provided below fourth frame 45. Support arm 71 extends in the left-right direction. Third wheel 33 is supported by support arm 71. Third wheel 33R is connected to the right end of support arm 71. Third wheel 33L is connected to the left end of support arm 71.

Support block 72 is connected to fourth frame 45. Support block 72 protrudes downward from fourth frame 45. By support block 72, support arm 71 is supported rotatably about a rotational center axis 136. Rotational center axis 136 extends in the front-rear direction. In the top view shown in FIG. 3, rotational center axis 136 overlaps centerline 110 of traveling body 12 extending in the front-rear direction. Support block 72 is provided with a shaft 73 protruding rearward from support block 72 and extending along rotational center axis 136, and shaft 73 is inserted in support arm 71 with a bearing interposed therebetween.

With such a configuration, support arm 71 swings about rotational center axis 136 as traveling body 12 travels on an uneven portion of the lower surface. Accordingly, third wheel 33 can more reliably be in contact with the lower surface to thereby stabilize traveling of moving device 100.

FIG. 5 is a top view showing a modification of the arrangement of the traveling motor in FIG. 3. Referring to FIG. 5, in this modification, traveling motor 57 outputs rotational motion about a ninth axis 161. Ninth axis 161 extends in the front-rear direction. Traveling motor 57 is provided below first frame 42. Reducer 56 slows down the rotational motion from traveling motor 57, converts the rotational motion about ninth axis 161 to rotational motion about second axis 122 by 90°, and transmits the rotational motion to first wheel 31.

According to this modification, since traveling motor 57 is not arranged in series with respect to first wheel 31 and reducer 56 which are arranged in the left-right direction, the distance between first wheel 31R and first wheel 31L in the left-right direction can be reduced.

FIG. 6 is a side view showing the traveling body in FIG. 1. In FIG. 6, a part of the structure of controller 14 in FIG. 1 is additionally shown.

Referring to FIGS. 1 and 6, controller 14 includes a bottom plate 76, an electronic device 82, and a robot support portion 81.

Bottom plate 76 is provided at the bottom of controller 14. Bottom plate 76 is formed of a metal sheet material of which top-bottom direction corresponds to the thickness direction. Electronic device 82 and robot support portion 81 are provided on bottom plate 76.

Electronic device 82 includes a control device 83. Control device 83 controls traveling body 12 and robot 16. Control device 83 controls traveling motor 57 of traveling body 12 and controls the driving motor of robot 16. Electronic device 82 may further include a laser sensor for detecting map information around traveling body 12. Battery 51 is disposed below electronic device 82.

Robot support portion 81 is provided frontward of electronic device 82. Robot support portion 81 supports robot 16 at a position separated away in the upward direction from bottom plate 76. Pedestal portion 26 of robot 16 is connected to robot support portion 81.

Cover 15 is formed of a sheet metal and presents the appearance of controller 14. Cover 15 is attached to bottom plate 76 with a fastening member such as bolt. Cover 15 is provided to cover electronic device 82 and robot support portion 81. Cover 15 forms an internal space on bottom plate 76 for accommodating electronic device 82 and robot support portion 81.

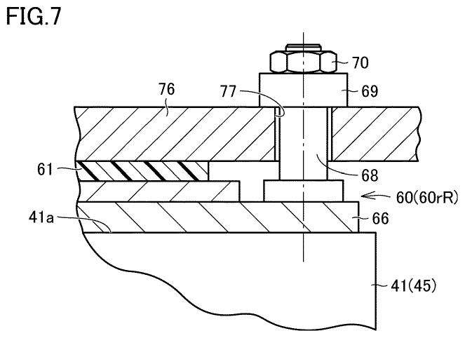

FIG. 7 is a cross-sectional view showing the traveling body in a range enclosed by a two-dot-dashed line VII in FIG. 4, and the bottom plate of the controller. Referring to FIGS. 2 to 7, traveling body 12 includes a holding unit 60. Holding unit 60 holds controller 14 with respect to traveling body 12.

Holding unit 60 includes an elastic pad 61. Elastic pad 61 is formed of an elastic member. Elastic pad 61 is formed of a sheet-shaped rubber member of which top-bottom direction corresponds to the thickness direction. Elastic pad 61 is interposed between bottom plate 76 of controller 14 and traveling body 12. Elastic pad 61 is interposed between bottom plate 76 of controller 14 and frame member 41. Controller 14 is mounted on traveling body 12 with elastic pad 61 interposed therebetween. Elastic pad 61 receives the weight of controller 14 and robot 16.

As shown in FIG. 7, holding unit 60 further includes a base plate 66, a positioning pin 68, and a fitting member 69.

Base plate 66 is formed of a metal sheet material of which top-bottom direction corresponds to the thickness direction. Base plate 66 is connected to frame member 41. Base plate 66 is mounted on a top surface 41a of frame member 41. Elastic pad 61 is fixed to base plate 66.

Positioning pin 68 has a pin shape protruding upward from base plate 66. Positioning pin 68 and elastic pad 61 adjacent to each other are disposed on base plate 66. Positioning pin 68 is inserted in bottom plate 76 in the top-bottom direction. A pin insertion hole 77 is formed in bottom plate 76. Pin insertion hole 77 extends through bottom plate 76 in the top-bottom direction. Positioning pin 68 is inserted in pin insertion hole 77.

Fitting member 69 is formed of a cylindrical body. Fitting member 69 fits on positioning pin 68 protruding from bottom plate 76. Fitting member 69 is fastened to positioning pin 68 with a nut 70. Bottom plate 76 is held between fitting member 69 and elastic pad 61 in the top-bottom direction. The fastening force applied from nut 70 to positioning pin 68 may not act on elastic pad 61.

As shown in FIGS. 2 and 3, traveling body 12 includes a plurality of holding units 60 (60fR, 60fL, 60rR, 60rL). The plurality of holding units 60 are arranged apart from each other in the front-rear direction and the left-right direction.

Holding unit 60fR and holding unit 60fL are provided on first frame 42R and first frame 42L, respectively. Holding unit 60fR is provided adjacent to second wheel 32R in the left-right direction. Holding unit 60fL is provided adjacent to second wheel 32L in the left-right direction. In each holding unit 60, specifically in each of holding unit 60fR and holding unit 60fL, elastic pad 61 and positioning pin 68 are provided adjacent to each other in the front-rear direction.

Holding unit 60rR and holding unit 60rL are provided on fourth frame 45. Holding unit 60rR is provided adjacent to third wheel 33R in the left-right direction. Holding unit 60rL is provided adjacent to third wheel 33L in the left-right direction. In each holding unit 60, specifically in each of holding unit 60rR and holding unit 60rL, elastic pad 61 and positioning pin 68 are provided adjacent to each other in the left-right direction.

As shown in FIG. 6, holding unit 60fR and holding unit 60fL are provided at respective positions that match the position of robot support portion 81 in the front-rear direction. Holding unit 60rR and holding unit 60rL are provided at respective positions that match the position of electronic device 82.

When moving device 100 travels over a protrusion such as a cable duct installed on a lower surface, excessively large vibration occurs. By the configuration in which controller 14 is elastically supported by elastic pad 61, such vibration can be prevented from being transmitted to controller 14. Accordingly, various electronic devices 82 provided in controller 14, especially control device 83 for controlling traveling body 12 and robot 16, can be protected appropriately against vibration.

Further, by using holding unit 60 in which elastic pad 61 and positioning pin 68 are integrated by base plate 66, both the elastic support of controller 14 and the positioning of controller 14 with respect to traveling body 12 can be achieved with a simple configuration. With such a configuration, bottom plate 76 is fixed to traveling body 12 with positioning pin 68, and cover 15 is attached to this bottom plate 76. In this case, as shown in FIG. 6, a hanging tool 350 such as an eye bolt can be attached to cover 15 to hoist and transport moving device 100.

Controller 14 may control moving device 100 at the timing when moving device 100 moves over a protrusion such as a cable duct on a lower surface, in such a manner that slows down the traveling speed of moving device 100. In this case, controller 14 may detect the timing to perform the speed control, based on map information of a factory or the like stored in advance in controller 14.

The following is a summary of the holding structure for controller 14 as described above: moving device 100 includes: traveling body 12; controller 14 that has bottom plate 76 and electronic device 82 mounted on bottom plate 76, and is mounted on traveling body 12; and holding unit 60 including elastic pad 61 interposed between bottom plate 76 and traveling body 12 and holding controller 14 with respect to traveling body 12.

Holding unit 60 further includes base plate 66 connected to traveling body 12, positioning pin 68 protruding upward from base plate 66 and inserted in bottom plate 76, and fitting member 69 that is fit on positioning pin 68 protruding from bottom plate 76. Elastic pad 61 is located adjacent to positioning pin 68 and fixed to base plate 66.

Moving device 100 includes a plurality of holding units 60 (60fL, 60fR, 60rL, 60rR) arranged apart from each other in the front-rear direction and the left-right direction.

Moving device 100 further includes robot 16. Controller 14 further includes robot support portion 81 that supports robot 16. Electronic device 82 includes control device 83 that controls traveling body 12 and robot 16.

Moving device 100 includes: traveling body 12 having (i) a wheel (31) and (ii) a mechanism (220, 211, 230) that includes urging means (220) extending in the front-rear direction for moving the wheel (31) toward a lower surface 310 by an urging force generated by the urging means (220); controller 14 that has bottom plate 76 and electronic device 82 mounted on bottom plate 76, and is mounted on traveling body 12; and holding unit 60 that includes elastic pad 61 interposed between bottom plate 76 and traveling body 12, and holds controller 14 with respect to traveling body 12.

Moving device 100 includes: traveling body 12; controller 14 that has bottom plate 76 and electronic device 82 mounted on bottom plate 76, and is mounted on traveling body 12; and holding unit 60 that includes elastic pad 61 interposed between bottom plate 76 and traveling body 12, and holds controller 14 with respect to traveling body 12. Traveling body 12 includes frame member 41 which is constituted of pipe-shaped frame members each having a rectangular closed cross section and in which wires are passed, and the direction in which the shorter sides of the rectangle extend corresponds to the top-bottom direction. Holding unit 60 is provided on frame member 41.

With such a configuration, when moving device 100 travels over a protrusion such as a cable duct, excessively large vibration occurs. By the configuration in which the controller is elastically supported by elastic pad 61, such vibration can be prevented from being transmitted to controller 14. Accordingly, electronic device 82 provided in controller 14 can be protected appropriately against vibration.

Further, the urging means (220) that generates an urging force for moving the wheel (31) toward lower surface 310 is provided to extend in the front-rear direction. With such a configuration and the configuration using elastic pad 61 rather than a damper in holding unit 60, vibration can more effectively be prevented from being transmitted to controller 14, and the height of traveling body 12 can be kept low.

Traveling body 12 includes frame member 41 constituted of pipe-shaped frame members each having a rectangular closed cross section, and wires are passed inside frame member 41. With such a configuration, the wires can be prevented from interfering with the wheels (31) included in traveling body 12 and/or interfering with lower surface 310, for example, and the rigidity of traveling body 12 can be kept high. Moreover, since the frame member 41 is provided such that the direction in which the shorter sides of the rectangle extend corresponds to the top-bottom direction, the height of traveling body 12 can be kept low.

### Support Structure for First Wheel

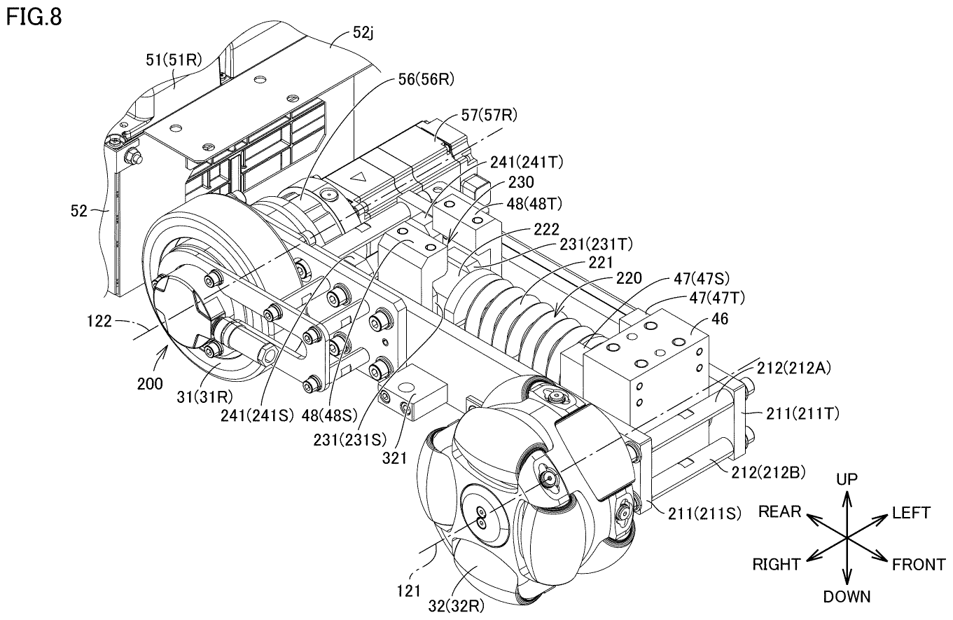

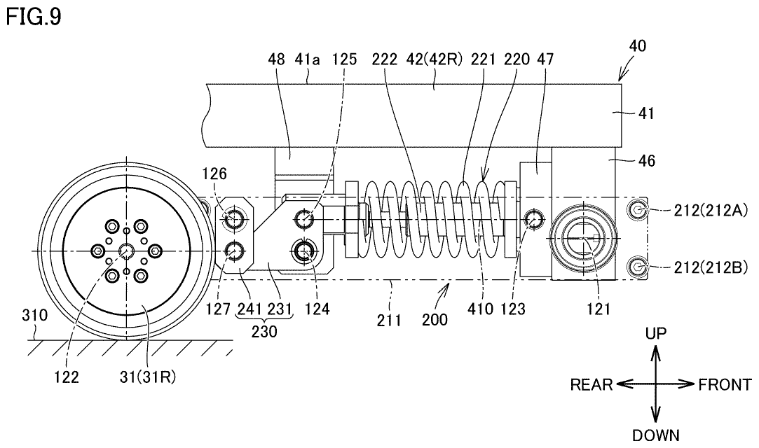

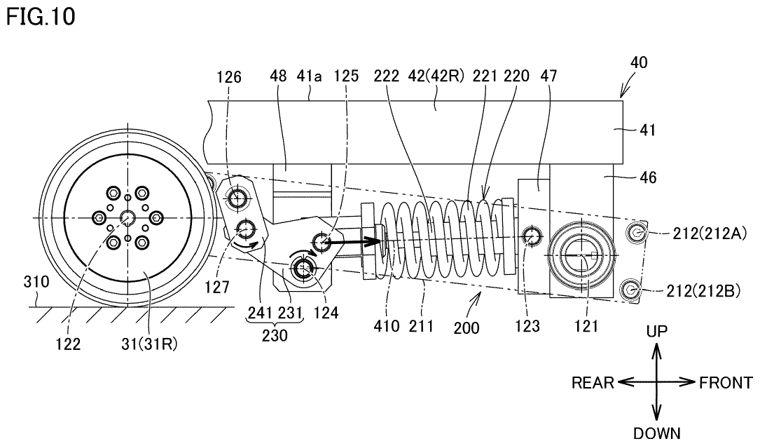

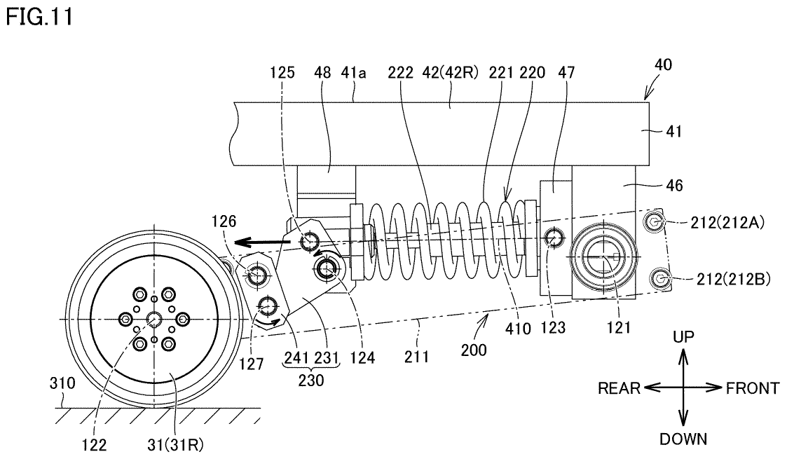

Next, a support structure for first wheel 31 is described. FIG. 8 is a perspective view showing the support structure for the first wheel in the traveling body in FIG. 2. FIG. 9 is a side view showing the support structure (a neutral state of a suspension mechanism) for the first wheel in FIG. 8. FIG. 10 is a side view showing the support structure (a shrunk state of the suspension mechanism) of the first wheel in FIG. 8. FIG. 11 is a side view showing the support structure (a stretched state of the suspension mechanism) for the first wheel in FIG. 8.

The neutral state of suspension mechanism 220 corresponds to a state of suspension mechanism 220 when the lowermost portion of first wheel 31 that is in contact with lower surface 310 and the lowermost portions of second wheel 32 and third wheel 33 that are in contact with lower surface 310 are located at the same height. The shrunk state of suspension mechanism 220 corresponds to a state of suspension mechanism 220 when suspension mechanism 220 has performed a shrinking operation from the neutral state. The stretched state of suspension mechanism 220 corresponds to a state of suspension mechanism 220 when suspension mechanism 220 has performed a stretching operation from the neutral state.

Referring to FIGS. 2, 3, and 8 to 11, base portion 40 further includes first block 46, second block 47 (47S, 47T), and third block 48 (48S, 48T).

First block 46, second block 47, and third block 48 are fixed to frame member 41, and are thus stationary members that are not caused to move by upward/downward movement of first wheel 31 and stretching/shrinking of suspension mechanism 220, as described later herein. In the left-right direction, first block 46, second block 47, and third block 48 are provided between a first arm member 211S and a second arm member 211T, which are described later herein.

First block 46 is connected to first frame 42. First block 46 protrudes downward from first frame 42. Second block 47 is connected to first block 46. Second block 47 is fastened to the rear surface of first block 46. Second block 47S and second block 47T are spaced apart from each other in the left-right direction.

Third block 48 is connected to first frame 42. Third block 48 protrudes downward from first frame 42. Third block 48 is provided at a position separated rearward from second block 47. Third block 48S and third block 48T are spaced apart from each other in the left-right direction.

Moving device 100 (traveling body 12) includes a wheel unit 200. In wheel unit 200, first wheel 31 is movably supported by base portion 40. In wheel unit 200, first wheel 31 is supported by base portion 40 in such a manner that first wheel 31 can move up and down.

Wheel unit 200 includes first wheel 31, arm member 211, and a coupling member 212. Arm member 211 extends in an arm shape in the front-rear direction. Arm member 211 is formed of a metal sheet material of which left-right direction corresponds to the thickness direction. Arm member 211 is supported rotatably about first axis 121 by base portion 40.

Arm members 211 extend in parallel in the front-rear direction, in the neutral state of suspension mechanism 220 shown in FIG. 9.

Wheel unit 200 includes first arm member 211S and second arm member 211T as arm members 211. First arm member 211S and second arm member 211T are spaced apart from each other in the left-right direction. First arm member 211S is provided outside traveling body 12 in the left-right direction with respect to second arm member 211T. First arm member 211S and second arm member 211T are coupled to each other by coupling member 212.

Coupling member 212 extends axially in the left-right direction. The opposite ends of coupling member 212 in the left-right direction are connected to first arm member 211S and second arm member 211T, respectively. Coupling member 212 is provided opposite to first wheel 31 with respect to first block 46. First wheel 31 is provided rearward of first block 46. First block 46 is provided rearward of coupling member 212. The distance between first block 46 and coupling member 212 in the front-rear direction is smaller than the distance between first block 46 and first wheel 31 in the front-rear direction.

Wheel unit 200 includes a first coupling member 212A and a second coupling member 212B as coupling members 212. First coupling member 212A and second coupling member 212B are spaced apart from each other in the top-bottom direction. First coupling member 212A is provided above second coupling member 212B.

By first block 46, arm member 211 is supported rotatably about first axis 121. First wheel 31 is disposed opposite to first block 46 with respect to first arm member 211S, in the left-right direction. By first arm member 211S, first wheel 31 is supported at a position separated from first axis 121 in its radial direction. By first arm member 211S, first wheel 31 is supported at a position separated rearward from first axis 121.

First wheel 31 may be supported by second arm member 211T, or may be supported by both first arm member 211S and second arm member 211T.

As shown in FIGS. 9 and 10, when first wheel 31 moves upward from the neutral state of suspension mechanism 220, arm member 211 swings clockwise about first axis 121. As shown in FIGS. 9 and 11, when first wheel 31 moves downward from the neutral state of suspension mechanism 220, arm member 211 swings counterclockwise about first axis 121.

Moving device 100 (traveling body 12) further includes suspension mechanism 220. Suspension mechanism 220 generates an urging force to act on first wheel 31.

Suspension mechanism 220 extends in the front-rear direction. Suspension mechanism 220 is provided in a horizontal posture such that the total length of suspension mechanism 220 in the front-rear direction is larger than the total height of suspension mechanism 220 in the top-bottom direction.

Suspension mechanism 220 is disposed such that at least a part of suspension mechanism 220 overlaps arm member 211 as seen in the left-right direction. Suspension mechanism 220 is provided between first arm member 211S and second arm member 211T in the left-right direction. Suspension mechanism 220 is provided below frame member 41 (first frame 42). Suspension mechanism 220 is provided at a position lower than the topmost portions of second wheel 32 and third wheel 33. Suspension mechanism 220 is provided between first axis 121 and second axis 122 in the front-rear direction. Suspension mechanism 220 is disposed frontward of reducer 56.

First axis 121 is located opposite to first wheel 31 with respect to suspension mechanism 220 in the front-rear direction. Battery 51 is disposed opposite to arm member 211 with respect to first wheel 31 in the front-rear direction.

By base portion 40, one end (front end) of suspension mechanism 220 is supported rotatably about a third axis 123. Third axis 123 is an imaginary straight line corresponding to the rotational center of suspension mechanism 220, and extends in the left-right direction. Third axis 123 is located between first axis 121 and second axis 122 in the front-rear direction. Third axis 123 is located above first axis 121. Second block 47 is provided on third axis 123.

Suspension mechanism 220 includes a spring member 221 and a shock absorber 222. Shock absorber 222 is constituted of a cylinder filled with oil, gas, or the like, and a rod combined with the cylinder and capable of stretching and shrinking in the front-rear direction. The front end of the cylinder of shock absorber 222 is inserted between second block 47S and second block 47T, and supported rotatably about third axis 123 by second block 47S and second block 47T.

Spring member 221 is configured as a coil spring. Spring member 221 is combined with the outer periphery of shock absorber 222. Spring member 221 exerts a spring force in the stretching direction on the rod of shock absorber 222.

Moving device 100 (traveling body 12) further includes a link mechanism 230. Link mechanism 230 is connected to suspension mechanism 220 and wheel unit 200. Link mechanism 230 is connected to the other end (rear end) of suspension mechanism 220. Link mechanism 230 is connected to the rear end of the rod of shock absorber 222. Link mechanism 230 is connected to arm member 211. Link mechanism 230 receives an urging force from suspension mechanism 220 to press first wheel 31 toward lower surface 310.

Link mechanism 230 is provided between first axis 121 and second axis 122 in the front-rear direction. Link mechanism 230 is provided between first arm member 211S and second arm member 211T in the left-right direction. Link mechanism 230 is provided below frame member 41 (first frame 42).

Link mechanism 230 includes a first plate 231 (231S, 231T) and a second plate 241 (241S, 241T).

First plate 231 is formed of a sheet member of which left-right direction corresponds to the thickness direction. By base portion 40, first plate 231 is supported rotatably about a fourth axis 124. Fourth axis 124 is an imaginary straight line corresponding to the rotational center of first plate 231 with respect to base portion 40 (third block 48), and extends in the left-right direction. Fourth axis 124 is located between first axis 121 and second axis 122 in the front-rear direction. Fourth axis 124 is located between third axis 123 and a sixth axis 126, which is described later herein, in the front-rear direction.

By third block 48, first plate 231 is supported rotatably about fourth axis 124. As shown in FIG. 8, first plate 231 is provided between third block 48S and third block 48T in the left-right direction. First plate 231S is provided adjacent to third block 48S in the left-right direction. First plate 231T is provided adjacent to third block 48T in the left-right direction. A shaft member (not shown) located between third block 48S and third block 48T and extending along fourth axis 124 is inserted through first plate 231S and first plate 231T. A bearing such as a slide bearing is interposed between the shaft member and first plate 231S/first plate 231T. The bearing has a cylindrical shape with fourth axis 124 as its center, and allows relative rotational movement between the shaft member and first plate 231S/first plate 231T.

First plate 231S and first plate 231T are spaced apart from each other in the left-right direction. The rear end of the rod of shock absorber 222 is inserted between first plate 231S and first plate 231T in the left-right direction.

First plate 231 (231S, 231T) is connected to the other end of suspension mechanism 220 (to the rear end of the rod of shock absorber 222), so as to be rotatable about a fifth axis 125. Fifth axis 125 is an imaginary straight line corresponding to the rotational center of first plate 231 with respect to the rear end of the rod of shock absorber 222, and extends in the left-right direction. Fifth axis 125 is located away from fourth axis 124 in its radial direction. Fifth axis 125 is located above fourth axis 124. A shaft member (not shown) extending along fifth axis 125 between first plate 231S and first plate 231T is inserted in the rear end of the rod of shock absorber 222.

Second plate 241 is formed of a sheet member of which left-right direction corresponds to the thickness direction. Second plate 241 partially overlaps first plate 231 in the left-right direction. Second plate 241 overlaps first plate 231 in a range including at least a seventh axis 127 described later herein. Second plate 241 is provided between first arm member 211S and second arm member 211T in the left-right direction. Second plate 241S is provided adjacent to first arm member 211S in the left-right direction. Second plate 241T is provided adjacent to second arm member 211T in the left-right direction.

Second plate 241 is connected to arm member 211 so as to be rotatable about sixth axis 126. Sixth axis 126 is an imaginary straight line corresponding to the rotational center of second plate 241 with respect to arm member 211, and extends in the left-right direction. Sixth axis 126 is located between fourth axis 124 and second axis 122 in the front-rear direction. Sixth axis 126 is located between fifth axis 125 and second axis 122 in the front-rear direction. A shaft member (not shown) extending along sixth axis 126 between first arm member 211S and second arm member 211T is inserted through second plate 241S and second plate 241T.

Second plate 241 is connected to first plate 231 rotatably about seventh axis 127. Seventh axis 127 is an imaginary straight line corresponding to the rotational center of second plate 241 with respect to first plate 231, and extends in the left-right direction. Seventh axis 127 is located away from sixth axis 126 in its radial direction. Seventh axis 127 is located away from fourth axis 124 in its radial direction. Seventh axis 127 is located between fourth axis 124 and second axis 122 in the front-rear direction. Seventh axis 127 is located rearward of fourth axis 124. Seventh axis 127 is located below sixth axis 126. A shaft member (not shown) extending along seventh axis 127 is inserted through first plate 231S, second plate 241S, first plate 231T, and second plate 241T. A bearing such as a slide bearing is interposed between the shaft member and second plate 241S/second plate 241T. The bearing has a cylindrical shape with seventh axis 127 as its center, and allows relative rotational movement between the shaft member and second plate 241S/second plate 241T.

The distance between fourth axis 124 and seventh axis 127 is larger than the distance between fourth axis 124 and fifth axis 125.

An urging force from suspension mechanism 220 generated by a spring force of spring member 221 is transmitted to arm member 211 via first plate 231 and second plate 241. Arm member 211 receives the urging force from suspension mechanism 220 to be urged counterclockwise about first axis 121. Accordingly, first wheel 31 supported by arm member 211 is pressed against lower surface 310.

Referring to FIGS. 9 and 10, when first wheel 31 moves upward as the first wheel passes over a protruded portion on lower surface 310, arm member 211 swings clockwise about first axis 121. As arm member 211 swings, second plate 241 swings counterclockwise about sixth axis 126 and first plate 231 swings clockwise about fourth axis 124. As first plate 231 swings, fifth axis 125 moves in the direction toward third axis 123, to thereby cause suspension mechanism 220 to be compressed. At this time, while a relative positional deviation occurs between third axis 123 and fifth axis 125 that support the opposite ends, respectively, of suspension mechanism 220, this positional deviation is absorbed by suspension mechanism 220 swinging about third axis 123.

Referring to FIGS. 9 and 11, when first wheel 31 moves downward as the first wheel passes over a depressed portion in lower surface 310, arm member 211 swings counter-clockwise about first axis 121. As arm member 211 swings, second plate 241 swings clockwise about sixth axis 126 and first plate 231 swings counterclockwise about fourth axis 124. As first plate 231 swings, fifth axis 125 moves in the direction away from third axis 123, to thereby cause suspension mechanism 220 to stretch. At this time, while a relative positional deviation occurs between third axis 123 and fifth axis 125 that support the opposite ends, respectively, of suspension mechanism 220, this positional deviation is absorbed by suspension mechanism 220 swinging about third axis 123.

In the neutral state of suspension mechanism 220 shown in FIG. 9, third axis 123 is located rearward of and above first axis 121. Fourth axis 124 and fifth axis 125 are located at respective positions that are rearward of third axis 123 and match each other in the front-rear direction. Fifth axis 125 is located at a position above fourth axis 124. Sixth axis 126 and seventh axis 127 are located at respective positions that are rearward of fourth axis 124 and fifth axis 125 and match each other in the front-rear direction. Second axis 122 is located at a position rearward of sixth axis 126 and seventh axis 127. Third axis 123, fifth axis 125, and sixth axis 126 are located at respective positions that match each other in the top-bottom direction (located at the same height). Fourth axis 124, seventh axis 127, and second axis 122 are located at respective positions that match each other in the top-bottom direction. First axis 121 is located at a position below third axis 123, fifth axis 125, and sixth axis 126 and above fourth axis 124, seventh axis 127, and second axis 122.

In the shrunk state of suspension mechanism 220 shown in FIG. 10, first axis 121, third axis 123, fifth axis 125, fourth axis 124, seventh axis 127, sixth axis 126, and second axis 122 are arranged in this order from the front side toward the rear side of traveling body 12. Second axis 122 is located at a position above first axis 121. Fifth axis 125 is located at a position above fourth axis 124, seventh axis 127 is located at a position above fifth axis 125, and sixth axis 126 is located at a position above seventh axis 127. First axis 121 is located at a position above fourth axis 124 and below fifth axis 125. Second axis 122 is located at a position above seventh axis 127 and below sixth axis 126.

In the stretched state of suspension mechanism 220 shown in FIG. 11, first axis 121, third axis 123, fourth axis 124, fifth axis 125, seventh axis 127, sixth axis 126, and second axis 122 are arranged in this order from the front side toward the rear side of traveling body 12. Second axis 122 is located at a position below first axis 121. Sixth axis 126 is located at a position above seventh axis 127, fourth axis 124 is located at a position above sixth axis 126, and fifth axis 125 is located at a position above fourth axis 124. First axis 121 is located at a position above fourth axis 124 and below fifth axis 125. Second axis 122 is located at a position below seventh axis 127.

As described above, traveling body 12 according to the present embodiment includes: base portion 40; wheel unit 200 including first wheel 31, first wheel 31 being supported movably by base portion 40; suspension mechanism 220 that generates an urging force; and link mechanism 230 connected to suspension mechanism 220 and wheel unit 200 and subjected to the urging force from suspension mechanism 220 to press first wheel 31 toward lower surface 310.

In traveling body 12 configured in such a manner, first wheel 31 is pressed toward lower surface 310 by the urging force from suspension mechanism 220, and therefore, the ground contact force of first wheel 31 can be increased to improve the traveling performance of traveling body 12. Traveling body 12 thus improved in its traveling performance can travel over a protrusion such as a cable duct, which thereby enables improvement of the mobility of moving device 100. With such a configuration, link mechanism 230 can appropriately convert the direction of the urging force from suspension mechanism 220 to transmit the urging force to wheel unit 200, and therefore, the posture of suspension mechanism 220 mounted on traveling body 12 can be set freely. Thus, when suspension mechanism 220 is mounted, the height of traveling body 12 can be kept low.

In the case where the suspension mechanism is installed in the upright posture, the overall length of the coil spring has to be shortened because there is a restriction on the height of the traveling body. In this case, the ratio of the length of the coil spring to be stretched/shrunk to the overall length of the coil spring is increased, and therefore, a sufficient durability of the coil spring cannot be ensured. In contrast, according to the present embodiment, suspension mechanism 220 is installed in the horizontal posture, and therefore, it is easy to ensure a large space in the stretching/shrinking direction of spring member 221, for installation of suspension mechanism 220. Thus, the above-mentioned problem with the durability of spring member 221 can be overcome.

Wheel unit 200 further includes arm member 211 supported by base portion 40 rotatably about first axis 121 extending in the left-right direction. First wheel 31 is supported by arm member 211 rotatably about second axis 122 extending in the left-right direction and located away from first axis 121 in the front-rear direction.

With such a configuration, first wheel 31 can be moved in the circumferential direction of first axis 121, as arm member 211 swings about first axis 121. Thus, wheel unit 200 in which first wheel 31 is supported movably by base portion 40 can be implemented with a simple configuration.

Suspension mechanism 220 is disposed in such a manner that at least a part of suspension mechanism 220 overlaps arm member 211 as seen in the left-right direction.

With such a configuration, the height of traveling body 12 can be kept lower when suspension mechanism 220 is mounted.

Suspension mechanism 220 is disposed between first axis 121 and second axis 122 in the front-rear direction.

With such a configuration, suspension mechanism 220 can be mounted compactly in the front-rear direction.

First axis 121 is located opposite to first wheel 31 with respect to suspension mechanism 220 in the front-rear direction. Traveling body 12 further includes battery 51 disposed opposite to arm member 211 with respect to first wheel 31 in the front-rear direction.

In traveling body 12 configured in such a manner, the length of arm member 211 in the front-rear direction is set larger than the length of suspension mechanism 220 in the front-rear direction, by the configuration in which first axis 121 is located opposite to first wheel 31 with respect to suspension mechanism 220 in the front-rear direction. In this case, as arm member 211 swings about first axis 121, first wheel 31 moves in the circumferential direction of first axis 121 with a smaller curvature of the trajectory of first wheel 31, so that first wheel 31 is unlikely to interfere with battery 51 (battery case 52 in FIG. 8). Thus, battery 51 can be disposed closer to first wheel 31, and therefore, traveling body 12 can be configured compactly.

Traveling body 12 further includes second wheel 32 supported by base portion 40 (first block 46) rotatably about first axis 121.

With such a configuration, the support structure for arm member 211 and second wheel 32 can be simplified by allowing arm member 211 and second wheel 32 to have the common rotational center axis.

One end of suspension mechanism 220 is supported by base portion 40 rotatably about third axis 123 extending in the left-right direction and located between first axis 121 and second axis 122 in the front-rear direction. Link mechanism 230 includes: first plate 231 supported by base portion 40 rotatably about fourth axis 124 extending in the left-right direction and located between third axis 123 and second axis 122 in the front-rear direction, and connected to the other end of suspension mechanism 220 so as to be rotatable about fifth axis 125 extending in the left-right direction and located radially away from fourth axis 124; and second plate 241 connected to arm member 211 so as to be rotatable about sixth axis 126 extending in the left-right direction and located between fourth axis 124 and second axis 122 in the front-rear direction, and connected to first plate 231 so as to be rotatable about seventh axis 127 extending in the left-right direction and located radially away from each of fourth axis 124 and sixth axis 126.

With such a configuration, stretching/shrinking of suspension mechanism 220 and movement (up-and-down movement) of first wheel 31 can be coordinated with each other through swinging of suspension mechanism 220 about third axis 123 with respect to base portion 40, swinging of first plate 231 about fourth axis 124 with respect to base portion 40, swinging of second plate 241 about sixth axis 126 with respect to arm member 211, and swinging of arm member 211 about first axis 121 with respect to base portion 40.

The distance between fourth axis 124 and seventh axis 127 is larger than the distance between fourth axis 124 and fifth axis 125.

With such a configuration, the length over which first wheel 31 moves (the stroke of the up-and-down movement of the first wheel) can be set large while the length of suspension mechanism 220 to be stretched/shrunk is kept small.

Wheel unit 200 also includes a pair of arm members 211 (211S, 211T) spaced apart from each other in the left-right direction. Suspension mechanism 220 is disposed between arm members 211 (211S, 211T) of the pair.

With such a configuration, a sufficient rigidity of arm member 211 connecting suspension mechanism 220 and first wheel 31 to each other can be ensured.

Base portion 40 also includes frame member 41 (first frame 42) disposed in parallel to lower surface 310 and extending in the front-rear direction. Suspension mechanism 220 is disposed below frame member 41 (first frame 42).

With such a configuration, the height of traveling body 12 can be kept lower when suspension mechanism 220 is mounted.

Traveling body 12 according to the present embodiment includes: base portion 40; wheel unit 200 including first wheel 31 serving as a driving wheel, first wheel 31 being supported movably by base portion 40; second wheel 32 spaced apart from first wheel 31 in the front-rear direction, and serving as a driven wheel that is driven to rotate as first wheel 31 rotates; suspension mechanism 220 that generates an urging force; and link mechanism 230 that is connected to suspension mechanism 220 and wheel unit 200, and subjected to the urging force from suspension mechanism 220 to press first wheel 31 toward lower surface 310. Suspension mechanism 220 and link mechanism 230 are disposed between first wheel 31 and second wheel 32 in the front-rear direction. With such a configuration, suspension mechanism 220 and link mechanism 230 are disposed between first wheel 31 and second wheel 32 in the front-rear direction, and therefore, suspension mechanism 220 and link mechanism 230 can be disposed by effectively utilizing the space ensured between the driving wheel and the driven wheel in the front-rear direction.

Moreover, in the front-rear direction, suspension mechanism 220 is disposed at a position closer to second wheel 32 spaced apart from first wheel 31 in the front-rear direction, than to first wheel 31 on which the urging force is to be exerted. Thus, suspension mechanism 220 and link mechanism 230 can be disposed by using a larger space ensured between the driving wheel and the driven wheel in the front-rear direction.

As shown in FIGS. 6 and 8 to 11, suspension mechanism 220 and link mechanism 230 are disposed between first block 46 and traveling motor 57 in the front-rear direction. Suspension mechanism 220 and link mechanism 230 face traveling motor 57 in the front-rear direction.

First axis 121 corresponds to the rotational center axis of second wheel 32. First axis 121 corresponds to the rotational center axis of arm member 211. Second axis 122 corresponds to the rotational center axis of first wheel 31. Third axis 123 corresponds to the rotational center axis of suspension mechanism 220 with respect to base portion 40. Fifth axis 125 corresponds to the rotational center axis at which link mechanism 230 and suspension mechanism 220 are rotatably connected to each other. Sixth axis 126 corresponds to the rotational center axis at which arm member 211 and link mechanism 230 are rotatably connected to each other.

Suspension mechanism 220 is disposed at a position closer to second wheel 32 than to first wheel 31 in the front-rear direction. The distance between second wheel 32 and suspension mechanism 220 in the front-rear direction is smaller than the distance between first wheel 31 and suspension mechanism 220 in the front-rear direction. The distance between first axis 121 and third axis 123 in the front-rear direction is smaller than the distance between fifth axis 125 and second axis 122 in the front-rear direction. Link mechanism 230 is disposed at a position closer to first wheel 31 than to second wheel 32 in the front-rear direction. The distance between link mechanism 230 and first wheel 31 in the front-rear direction is smaller than the distance between link mechanism 230 and second wheel 32 in the front-rear direction. The distance between sixth axis 126 and second axis 122 in the front-rear direction is smaller than the distance between fifth axis 125 and first axis 121 in the front-rear direction.

The front end of suspension mechanism 220 is disposed at a position closer to second wheel 32 than to first wheel 31 in the front-rear direction. The distance between third axis 123 and first axis 121 in the front-rear direction is smaller than the distance between third axis 123 and second axis 122 in the front-rear direction. The rear end of suspension mechanism 220 is disposed at a position closer to first wheel 31 than to second wheel 32 in the front-rear direction. The distance between fifth axis 125 and second axis 122 in the front-rear direction is smaller than the distance between fifth axis 125 and first axis 121 in the front-rear direction.

As seen in the left-right direction, an end (the front end) of suspension mechanism 220 in the front-rear direction overlaps second wheel 32. As seen in the left-right direction, suspension mechanism 220 is disposed at a position where suspension mechanism 220 does not overlap first wheel 31. As seen in the left-right direction, link mechanism 230 may be disposed at a position overlapping first wheel 31 or may be disposed at a position that does not overlap first wheel 31.

Suspension mechanism 220 and link mechanism 230 are disposed inside traveling body 12, i.e., inside first wheel 31 and second wheel 32 in the left-right direction. Suspension mechanism 220 and link mechanism 230 are disposed between first wheel 31R and first wheel 31L in the left-right direction. Suspension mechanism 220 and link mechanism 230 are disposed between second wheel 32R and second wheel 32L in the left-right direction.

As shown in FIGS. 9 to 11, suspension mechanism 220 can stretch and shrink with a predetermined axis 410 located at its center. Predetermined axis 410 intersects third axis 123 and fifth axis 125. Suspension mechanism 220 can stretch and shrink in the axial direction of predetermined axis 410 in such a manner that the distance between third axis 123 and fifth axis 125 changes. Predetermined axis 410 of suspension mechanism 220 corresponds to the central axis of spring member 221. While suspension mechanism 220 stretches/shrinks, the angle formed by predetermined axis 410 with a horizontal line extending in the front-rear direction changes. The angle formed by predetermined axis 410 with the horizontal line extending in the front-rear direction may be 30° or less, may be 15° or less, may be 10° or less, or may be 5° or less.

Traveling body 12 includes: base portion 40; wheel unit 200 including first wheel 31 serving as a driving wheel, first wheel 31 being supported movably by base portion 40; second wheel 32 spaced apart from first wheel 31 in the front-rear direction, and serving as a driven wheel that is driven to rotate as first wheel 31 rotates; suspension mechanism 220 that generates an urging force; and link mechanism 230 that is connected to suspension mechanism 220 and wheel unit 200, and subjected to the urging force from suspension mechanism 220 to press first wheel 31 toward lower surface 310. Base portion 40 includes first block 46. Wheel unit 200 further includes arm member 211 supported by first block 46 rotatably about first axis 121 extending in the left-right direction. First wheel 31 is supported by arm member 211 rotatably about second axis 122 extending in the left-right direction and located away from first axis 121 in the front-rear direction. Second wheel 32 is rotatably supported by first block 46.

With such a configuration, arm member 211 and second wheel 32 are rotatably supported by the same first block 46, and therefore, the support structure for arm member 211 and second wheel 32 can be simplified.

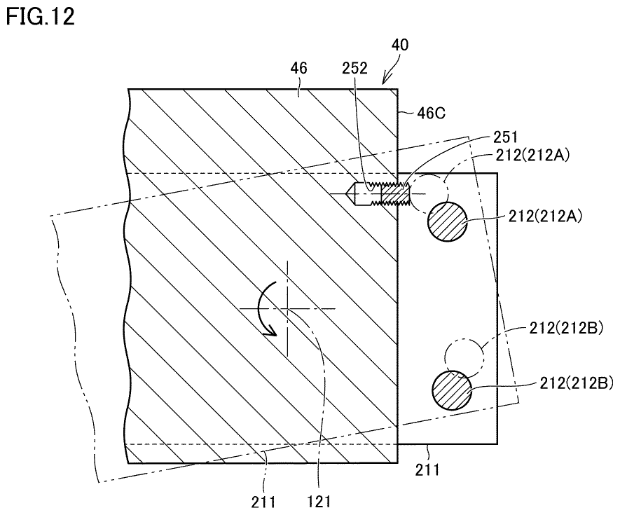

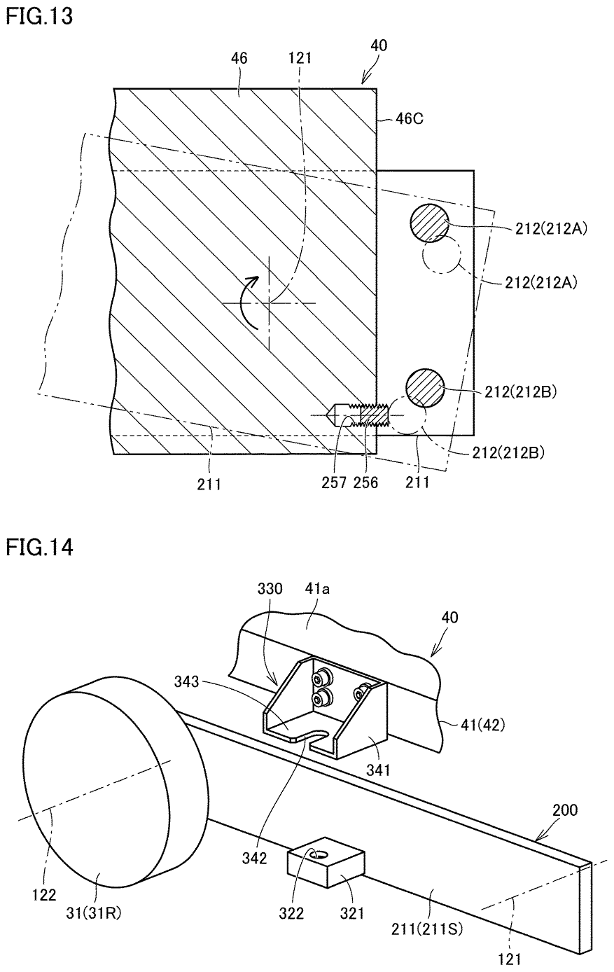

FIG. 12 is a cross-sectional view schematically showing a mechanism for restricting a downward swing end of the arm member. FIG. 13 is a cross-sectional view schematically showing a mechanism for restricting an upward swing end of the arm member.

Referring to FIGS. 2, 12 and 13, coupling member 212 is disposed with a gap to first block 46 in the circumferential direction of first axis 121. First coupling member 212A is disposed with a gap to first block 46 in one direction (the counterclockwise direction in FIGS. 12 and 13) along the circumferential direction of first axis 121. Second coupling member 212B is disposed with a gap to first block 46 in the other direction (the clockwise direction in FIGS. 12 and 13) along the circumferential direction of first axis 121.

First block 46 has a front surface 46C. Front surface 46C is a flat surface facing forward and orthogonal to the front-rear direction. In the neutral state of suspension mechanism 220, a gap is present between front surface 46C and first coupling member 212A/second coupling member 212B in the front-rear direction.

First block 46 is provided with a first female screw hole 252 and a second female screw hole 257. First female screw hole 252 and second female screw hole 257 extend in the front-rear direction and open in front surface 46C. First female screw hole 252 and second female screw hole 257 are arranged side by side in the top-bottom direction, at the same interval therebetween as the interval between first coupling member 212A and second coupling member 212B.

Traveling body 12 further includes a first fastening member 251 and a second fastening member 256. First fastening member 251 and second fastening member 256 are each formed as a hollow set screw. First fastening member 251 and second fastening member 256 are screwed into first female screw hole 252 and second female screw hole 257, respectively.

In one direction (the counterclockwise direction in FIG. 12) along the circumferential direction of first axis 121, first coupling member 212A is disposed with a gap to the leading end of first fastening member 251. In the other direction (the clockwise direction in FIG. 13) along the circumferential direction of first axis 121, second coupling member 212B is disposed with a gap to the leading end of second fastening member 256.

Coupling member 212 functions not only as means for coupling first arm member 211S and second arm member 211T to each other, but also as means for restricting the swing end of arm member 211 about first axis 121.

As shown in FIG. 12, as first wheel 31 moves downward, first coupling member 212A comes into contact with first fastening member 251, so that the downward swing end of arm member 211 about first axis 121 is restricted. By increasing or decreasing the length of the protruding portion of first fastening member 251 from first female screw hole 252, the angle of the downward swing end of arm member 211 can be adjusted. As shown in FIG. 13, as first wheel 31 moves upward, second coupling member 212B comes into contact with second fastening member 256, so that the upward swing end of arm member 211 about first axis 121 is restricted. By increasing or decreasing the length of the protruding portion of second fastening member 256 from second female screw hole 257, the angle of the upward swing end of arm member 211 can be adjusted.

In the present embodiment, wheel unit 200 includes, as coupling member 212, first coupling member 212A disposed with a gap to first block 46 in one direction along the circumferential direction of first axis 121, and second coupling member 212B spaced apart from first coupling member 212A and disposed with a gap to first block 46 in the other direction along the circumferential direction of first axis 121. With such a configuration, first arm member 211S and second arm member 211T can be coupled to each other more firmly and the downward swing end and the upward swing end of arm member 211 can be restricted respectively by first coupling member 212A and second coupling member 212B.

Further, coupling member 212 (212A, 212B) is disposed opposite to first wheel 31 with respect to first block 46 (disposed frontward of first block 46), and suspension mechanism 220 and link mechanism 230 are disposed opposite to coupling member 212 with respect to first block 46 (disposed rearward of first block 46). With such a configuration, coupling member 212 (212A, 212B), suspension mechanism 220, and link mechanism 230 can be efficiently arranged frontward and rearward of first block 46, without interference between coupling member 212 (212A, 212B) and suspension mechanism 220/link mechanism 230.

The means for restricting the swing end of arm member 211 is not limited to the above-described ones. For example, as first wheel 31 moves upward, the swing end of arm member 211 may be restricted by a configuration in which first wheel 31 comes into contact with a flange 52j of battery case 52 in FIG. 2. The swing end of arm member 211 may be restricted by the stroke end of shock absorber 222 in suspension mechanism 220.

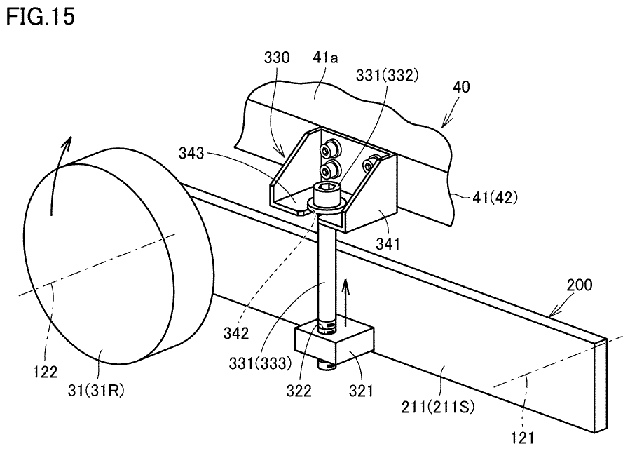

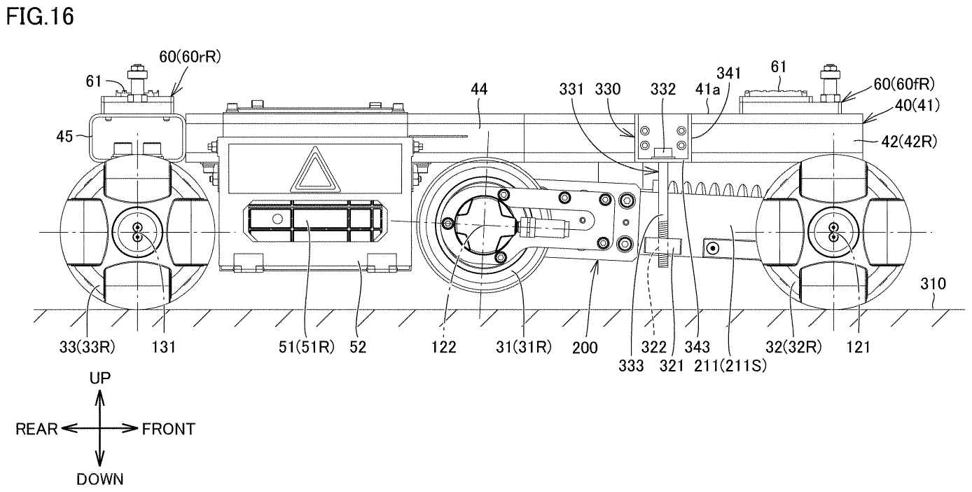

FIG. 14 is a perspective view showing a holding mechanism for the wheel unit (before a bolt is inserted). FIG. 15 is a perspective view showing the holding mechanism for the wheel unit (after the bolt is inserted). FIG. 16 is a side view showing the traveling body when the first wheel is lifted.

Referring to FIGS. 14 to 16, traveling body 12 further includes a holding mechanism 330. Holding mechanism 330 is configured to hold wheel unit 200 to keep a state in which first wheel 31 is separated from lower surface 310. Holding mechanism 330 is configured to hold arm member 211 (first arm member 211S) at a predetermined angle in the circumferential direction of first axis 121, to keep the state in which first wheel 31 is separated from lower surface 310.

Holding mechanism 330 includes a lifting block 321. Lifting block 321 is attached to wheel unit 200. Lifting block 321 is connected to arm member 211 (first arm member 211S). Lifting block 321 protrudes from arm member 211 (first arm member 211S) in the left-right direction. Lifting block 321 is provided with a threaded portion 322. Threaded portion 322 is formed as a female screw hole extending through lifting block 321 in the top-bottom direction.

Holding mechanism 330 further includes a bracket 341 and a bolt 331. Bracket 341 is attached to base portion 40. Bracket 341 is fastened to first frame 42 with a bolt(s). Bracket 341 is disposed to face lifting block 321 in the top-bottom direction. Bracket 341 is provided with a locking portion 342. Locking portion 342 is formed as a bolt insertion hole extending through a bottom plate 343 of bracket 341 in the top-bottom direction. A shaft portion 333 of bolt 331 is inserted in locking portion 342 and screwed into threaded portion 322. A head portion 332 of bolt 331 is locked by the edge of locking portion 342 of bottom plate 343.

If battery 51 is out of charge during transportation by moving device 100, an operator has to manually move moving device 100 to a charging site. In this case, if first wheel 31 connected to traveling motor 57 remains in contact with lower surface 310, the labor required for moving this moving device 100 increases. In contrast, by fastening shaft portion 333 of bolt 331 into threaded portion 322, arm member 211 is swung clockwise about first axis 121 to generate the state in which first wheel 31 is separated from lower surface 310. Thus, only second wheel 32 and third wheel 33, which are driven wheels, are kept in contact with lower surface 310, so that moving device 100 can be moved with smaller labor.

The holding mechanism of the present invention is not particularly limited, as long as it can hold the wheel unit (arm member) at a predetermined angle in the circum-ferential direction of the first axis. For example, lifting block 321 may be attached to base portion 40 and bracket 341 may be attached to wheel unit 200. Further, the holding mechanism of the present invention may be constituted of a foot pedal provided at the front end of arm member 211 and locking means for locking arm member 211 swung upward by pressing the foot pedal.

The following is a summary of the restricting structure for the swing end of arm member 211 and the structure of holding mechanism 330 capable of holding wheel unit 200 as described above.

Traveling body 12 includes: base portion 40 including block (46); and wheel unit 200. Wheel unit 200 includes: first arm member 211S and second arm member 211T that are supported by block (46) rotatably about first axis 121 and spaced apart from each other in the axial direction of first axis 121; first wheel 31 rotatably supported at a position located radially away from first axis 121, by at least one of first arm member 211S and second arm member 211T; and coupling member 212 disposed with a gap to block (46) in the circumferential direction of first axis 121, and coupling first arm member 211S and second arm member 211T to each other.

Coupling member 212 includes first coupling member 212A disposed with a gap to block (46) in one direction along the circumferential direction of first axis 121, and second coupling member 212B spaced apart from first coupling member 212A and disposed with a gap to block (46) in the other direction along the circumferential direction of first axis 121.

Coupling member 212 is disposed opposite to first wheel 31 with respect to block (46). Traveling body 12 further includes: suspension mechanism 220 that generates an urging force; and link mechanism 230 that is connected to suspension mechanism 220 and wheel unit 200 and subjected to the urging force from suspension mechanism 220 to press first wheel 31 toward lower surface 310. Suspension mechanism 220 and link mechanism 230 are disposed opposite to coupling member 212 with respect to block (46).

First wheel 31 is a driving wheel to which rotational motion is input from traveling motor 57. Traveling body 12 further includes: driven wheel (32) rotatably supported by base portion 40; and holding mechanism 330 that holds first arm member 211S and second arm member 211T at a predetermined angle in the circumferential direction of first axis 121 to keep the state in which the driving wheel (31) is separated from lower surface 310.

Holding mechanism 330 includes: lifting block 321 provided with threaded portion 322 and attached to one of base portion 40 and wheel unit 200; bolt 331 that has head portion 332 and is screwed into threaded portion 322; and bracket 341 that has locking portion 342 capable of locking head portion 332, is attached to the other one of base portion 40 and wheel unit 200, and disposed to face lifting block 321 in the top-bottom direction.

Traveling body 12 includes: base portion 40 having block (46); and wheel unit 200. Wheel unit 200 includes: first arm member 211S and second arm member 211T that are supported by block (46) rotatably about first axis 121 and spaced apart from each other in the axial direction of first axis 121; first wheel 31 rotatably supported at a position located radially away from first axis 121, by at least one of first arm member 211S and second arm member 211T; and coupling member 212 disposed with a gap to block (46) in the circumferential direction of first axis 121, and coupling first arm member 211S and second arm member 211T to each other. Coupling member 212 includes: first coupling member 212A disposed with a gap to block (46) in one direction along the circumferential direction of first axis 121, and second coupling member 212B spaced apart from first coupling member 212A and disposed with a gap to block (46) in the other direction along the circumferential direction of first axis 121. When first arm member 211S and second arm member 211T swing about first axis 121 in the one direction, first wheel 31 moves downward and, when first arm member 211S and second arm member 211T swing about first axis 121 in the other direction, first wheel 31 moves upward. When first wheel 31 moves downward, first coupling member 212A comes into contact with block (46), so that respective swing ends of first arm member 211S and second arm member 211T in the one direction are restricted. When first wheel 31 is moved upward, second coupling member 212B comes into contact with block (46), so that respective swing ends of first arm member 211S and second arm member 211T in the other direction are restricted.

With such a configuration, coupling member 212 for coupling first arm member 211S and second arm member 211T to each other is brought into contact with block (46), to thereby restrict respective swing ends of first arm member 211S and second arm member 211T about first axis 121, and therefore, means for restricting the swing end of arm member 211 can be implemented with a simple configuration.

Further, as the coupling member, there are provided: first coupling member 212A that comes into contact with block (46) as first wheel 31 moves downward, to restrict respective swing ends of first arm member 211S and second arm member 211T in one direction; and second coupling member 212B that comes into contact with block (46) as first wheel 31 moves upward, to restrict respective swing ends of first arm member 211S and second arm member 211T in the other direction. With such a configuration, first arm member 211S and second arm member 211T can be coupled to each other more firmly by first coupling member 212A and second coupling member 212B, the swing end of arm member 211 in one direction can be restricted at an appropriate position (angle) through positioning of first coupling member 212A, and the swing end of arm member 211 in the other direction can be restricted at an appropriate position (angle) through positioning of second coupling member 212B.

### Modification of Moving Device

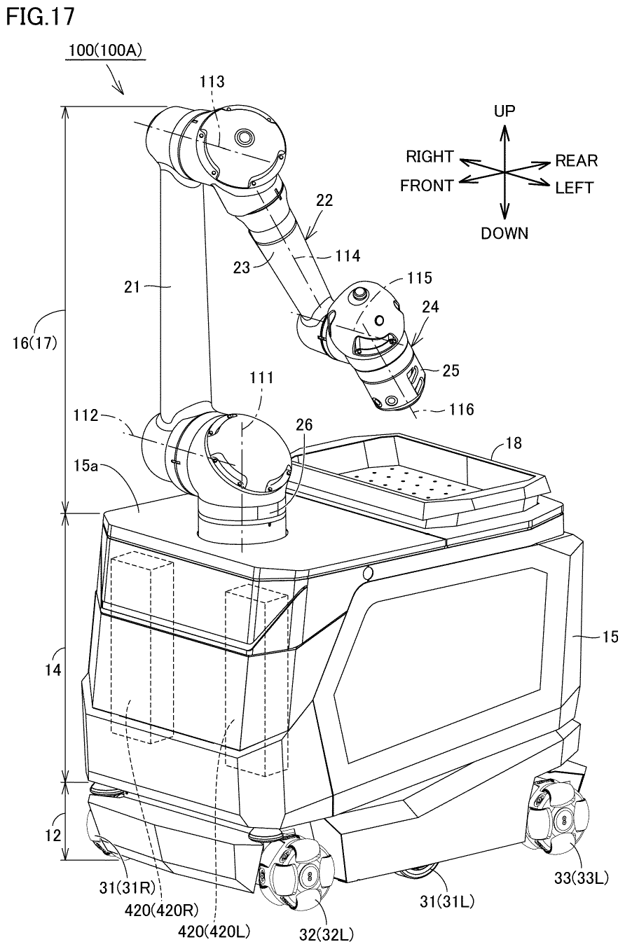

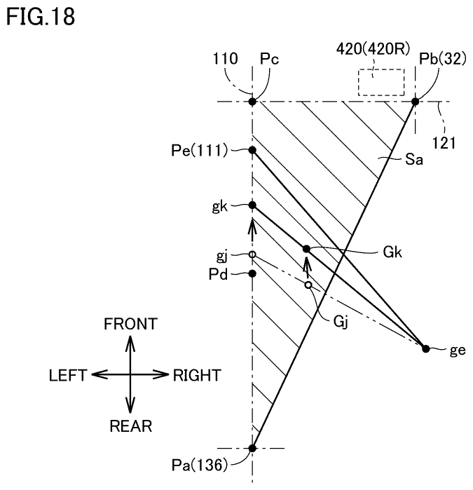

FIG. 17 is a perspective view showing a modification of the moving device in FIG. 1. FIG. 18 is a plan view for illustrating the position of the center of gravity in the moving device in FIG. 17.

Referring to FIGS. 17 and 18, a moving device 100A according to the present modification further includes a weight 420 (420R, 420L). Weight 420 is formed of a metal block. Weight 420 is formed of a rectangular parallelepiped block, and extends in such a manner that its longitudinal direction coincides with the top-bottom direction. Weight 420 is mounted on traveling body 12. Weight 420 is mounted on controller 14.

Weight 420 is disposed in a front portion of moving device 100A. Weight 420 is disposed frontward of first wheel 31. Weight 420 is disposed frontward of rotational center axis 111 of robot 16. Weight 420 may be disposed frontward of first axis 121, which is the rotational center axis of second wheel 32, or may be disposed to match first axis 121 in position in the front-rear direction. Weight 420 is disposed between bottom plate 76 (see FIG. 6) and top surface 15a of cover 15 in the top-bottom direction.

Weights 420R and 420L have the same shape and the same weight. Weights 420R and 420L are spaced apart from each other in the left-right direction. Weights 420R and 420L are disposed in lateral symmetry about centerline 110 (see FIG. 3) of traveling body 12 that extends in the front-rear direction.

In FIG. 18, centerline 110 of traveling body 12 and a region on the right side of centerline 110 are shown as examples. A first position Pa is located on centerline 110 and corresponds to the center position in the front-rear direction of rotational center axis 136 of support arm 71 shown in FIG. 4. A second position Pb corresponds to a position at which second wheel 32 (an outer ring of the omni wheel having the outer ring and an inner ring) contacts lower surface 310. A third position Pc corresponds to a position located on centerline 110 and matches second position Pb in the front-rear direction. A fourth position Pd corresponds to the center position in the front-rear direction between first position Pa and third position Pc. A fifth position Pe is located on centerline 110 and corresponds to the position of rotational center axis 111 of robot 16 (pedestal portion 26).

A right triangle area defined by lines connecting first position Pa, second position Pb, and third position Pc is a safe area Sa of the center-of-gravity position. As seen in plan view, the center of gravity of moving device 100A can be positioned inside safe area Sa, to thereby stabilize the posture of moving device 100A.

A center-of-gravity position ge indicates the center-of-gravity position of robot 16 alone when robot 16 loaded with a weight of 20 kg to be transported is operated rearward to the right. A center-of-gravity position gj indicates the center-of-gravity position of moving device 100 that does not include robot 16 in moving device 100 in FIG. 1 in which weight 420 is not provided. In this case, a center-of-gravity position Gj of the whole moving device 100 including robot 16 in FIG. 1 is defined to be located on a straight line connecting center-of-gravity position gj and center-of-gravity position ge, depending on the ratio between the weight of moving device 100 and the weight of robot 16.

In contrast, a center-of-gravity position gk indicates the center-of-gravity position of moving device 100A that does not include robot 16 in moving device 100A in FIG. 17 provided with weight 420. Because weight 420 is provided, center-of-gravity position gk is shifted frontward of center-of-gravity position gj. In this case, center-of-gravity position Gk of the whole moving device 100A including robot 16 in FIG. 17 is defined to be located on a straight line connecting center-of-gravity position gk and center-of-gravity position ge, depending on the ratio between the weight of moving device 100A and the weight of robot 16.

As robot 16 moves, the center-of-gravity position of moving device 100 is shifted to the left or right. In this case, if support arm 71 in FIG. 4 swings about rotational center axis 136, the posture of moving device 100 may be inclined considerably to the left or right. In contrast, in moving device 100A according to the present modification, weight 420 can be disposed to position center-of-gravity position Gk of the whole moving device 100A further inside safe area Sa. In this way, a change in posture of moving device 100A resultant from movement of robot 16 can further be reduced.

It should be construed that the embodiments disclosed herein are given by way of il-lustration in all respects, not by way of limitation. It is intended that the scope of the present invention is defined by claims, not by the description above, and encompasses all modifications and variations equivalent in meaning and scope to the claims.

### Reference Signs List

12 traveling body; 14 controller; 15 cover; 15a, 41a top surface; 16 robot; 17 robot arm; 18 tray; 21 first movable portion; 22 second movable portion; 23, 25 rotatable portion; 24 third movable portion; 26 pedestal portion; 31, 31L, 31R first wheel; 32, 32L, 32R second wheel; 33, 33L, 33R third wheel; 40 base portion; 41 frame member; 42, 42L, 42R first frame; 43 second frame; 44 third frame; 45 fourth frame; 46 first block; 46C front surface; 47, 47S, 47T second block; 48, 48S, 48T third block; 51, 51L, 51R battery; 52 battery case; 52j flange; 56, 56L, 56R reducer; 57, 57L, 57R traveling motor; 60, 60fL, 60fR, 60rL, 60rR holding unit; 61 elastic pad; 66 base plate; 68 positioning pin; 69 fitting member; 70 nut; 71 support arm; 72 support block; 73 shaft; 76, 343 bottom plate; 77 pin insertion hole; 81 robot support portion; 82 electronic device; 83 control device; 100, 100A moving device; 110 centerline; 111, 112, 113, 114, 115, 116, 136 rotational center axis; 121 first axis; 122 second axis; 123 third axis; 124 fourth axis; 125 fifth axis; 126 sixth axis; 127 seventh axis; 131 eighth axis; 161 ninth axis; 200 wheel unit; 211 arm member; 211S first arm member; 211T second arm member; 212 coupling member; 212A first coupling member; 212B second coupling member; 220 suspension mechanism; 221 spring member; 222 shock absorber; 230 link mechanism; 231, 231S, 231T first plate; 241, 241S, 241T second plate; 251 first fastening member; 252 first female screw hole; 256 second fastening member; 257 second female screw hole; 310 lower surface; 321 lifting block; 322 threaded portion; 330 holding mechanism; 331 bolt; 332 head portion; 333 shaft portion; 341 bracket; 342 locking portion; 350 hanging tool; 410 predetermined axis; 420, 420L, 420R weight; Gj, Gk, ge, gj, gk center-of-gravity position; Pa first position; Pb second position; Pc third position; Pd fourth position; Pe fifth position; Sa safe area.

1. A traveling body comprising:
a base portion;
a wheel unit including a first wheel serving as a driving wheel, the first wheel being supported movably by the base portion;
a second wheel spaced apart from the first wheel in a front-rear direction, and serving as a driven wheel that is driven to rotate as the first wheel rotates;
a suspension mechanism that generates an urging force; and
a link mechanism that is connected to the suspension mechanism and the wheel unit, and subjected to the urging force from the suspension mechanism to press the first wheel toward a lower surface, wherein the suspension mechanism and the link mechanism are disposed between the first wheel and the second wheel in the front-rear direction.

2. The traveling body according to claim 1, wherein
the wheel unit further includes an arm member supported by the base portion rotatably about a first axis extending in a left-right direction, and
the first wheel is supported by the arm member rotatably about a second axis extending in the left-right direction and located away from the first axis in the front-rear direction.

3. The traveling body according to claim 2, wherein the suspension mechanism is disposed in such a manner that at least a part of the suspension mechanism overlaps the arm member as seen in the left-right direction.

4. The traveling body according to claim 2, wherein the suspension mechanism is disposed between the first axis and the second axis in the front-rear direction.

5. The traveling body according to claim 2, wherein
one end of the suspension mechanism is supported by the base portion rotatably about a third axis extending in the left-right direction and located between the first axis and the second axis in the front-rear direction, and
the link mechanism includes:
a first plate supported by the base portion rotatably about a fourth axis extending in the left-right direction and located between the third axis and the second axis in the front-rear direction, and connected to the other end of the suspension mechanism rotatably about a fifth axis extending in the left-right direction and located radially away from the fourth axis; and
a second plate connected to the arm member rotatably about a sixth axis extending in the left-right direction and located between the fourth axis and the second axis in the front-rear direction, and connected to the first plate rotatably about a seventh axis extending in the left-right direction and located radially away from each of the fourth axis and the sixth axis.

6. The traveling body according to claim 1, wherein
the base portion includes a frame member disposed in parallel to the lower surface and extending in the front-rear direction, and the suspension mechanism is disposed below the frame member.

7. The traveling body according to claim 1, further comprising a third wheel spaced apart from the first wheel in the front-rear direction, disposed opposite to the second wheel with respect to the first wheel in the front-rear direction, and serving as a driven wheel that is driven to rotate as the first wheel rotates.

8. The traveling body according to claim 7, further comprising a battery disposed between the first wheel and the third wheel in the front-rear direction.

9. The traveling body according to claim 1, wherein
the suspension mechanism includes one end supported by the base portion rotatably about a third axis extending in a left-right direction, and
the one end of the suspension mechanism is located at a position overlapping the second wheel as seen in the left-right direction.

10. The traveling body according to claim 2, wherein the second wheel is supported rotatably about the first axis.

11. The traveling body according to claim 1, wherein the suspension mechanism is disposed at a position closer to the second wheel than to the first wheel in the front-rear direction.
